(19) United States
(12) Patent Application Publication
(10) Pub. No.: US 2013/0148337 A1
(43) Pub. Date: Jun. 13, 2013

(54) LED LAMP

(71) Applicants: Te-Sheng CHEN, Chu-Nan (TW); Sung-Hsiang YANG, Chu-Nan (TW)

(72) Inventors: Te-Sheng CHEN, Chu-Nan (TW); Sung-Hsiang YANG, Chu-Nan (TW)

(73) Assignee: FOXSEMICON INTEGRATED TECHNOLOGY, INC., Chu-Nan (TW)

(21) Appl. No.: 13/316,469

(22) Filed: Dec. 10, 2011

(51) Int. Cl. F21L 4/00; F21V 21/088; F21V 31/00; F21V 29/00; F21V 21/00; F21V 15/01

(52) U.S. Cl. 362/158; 362/249.02; 362/362

(57) ABSTRACT

An LED lamp includes a ceramic main body, an LED module mounted in the main body, a cover mounted on a top end of the main body and covering the LED module, and a connecting member electrically connecting the LED module and mounted on a bottom end of the main body.

### BACKGROUND

1. Technical Field

The present disclosure relates to lamps, and more particularly to an LED (light emitting diode) lamp having stable and reliable performance.

2. Description of Related Art

LEDs have many advantages, such as high luminosity, low operational voltage, low power consumption, easy driving, long-term reliability, environmental friendliness for not having to use mercury (Hg), and high impact resistance, which have LEDs to be widely used as light sources.

LED illumination devices, such as streetlight, spotlight, and searchlight, include an LED module and a metallic housing receiving the LED module therein. The heavy weight of the metallic housing is a disadvantage for disassembling or repairing of the devices, especially for the streetlight which is mounted on a lamp pole. In addition, the metallic housing is easy to be corroded, therefore the lifespan of the metallic housing is shortened and stability of the LED illumination device is adversely affected.

Accordingly, it is desirable to provide an LED lamp which can overcome the described limitations.

### BRIEF DESCRIPTION OF THE DRAWINGS

FIG. 1 is a cross-sectional view of an LED lamp of a first embodiment of the present disclosure.

FIG. 2 is an isometric view of an LED module of the LED lamp of FIG. 1.

FIG. 3 is a schematic, cross sectional view of the LED module of FIG. 2.

FIG. 4 is a cross-section of an LED lamp of a second embodiment of the present disclosure.

FIG. 5 is a cross-section of an LED lamp of a third embodiment of the present disclosure.

FIG. 6 is a cross-section of an LED lamp of a fourth embodiment of the present disclosure.

FIG. 7 is a cross-section of an LED lamp of a fifth embodiment of the present disclosure.

FIG. 8 is a circuit diagram of the LED module of FIG. 7.

FIG. 9 is a cross-section of an LED lamp of a sixth embodiment of the present disclosure.

### DETAILED DESCRIPTION

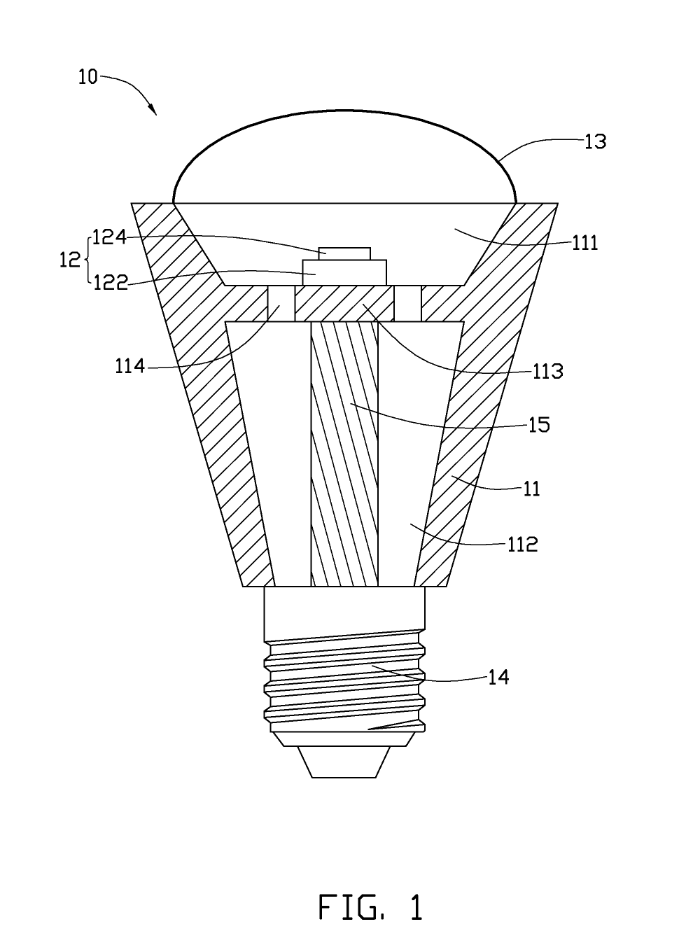

Referring to FIG. 1, an LED lamp 10 according to a first embodiment includes a hollow main body 11, an LED module 12 received in the main body 11, a cover 13 covering one end of the main body 11, a connecting member 14 mounted on another end of the main body 11, and a power module 15 received in the main body 11.

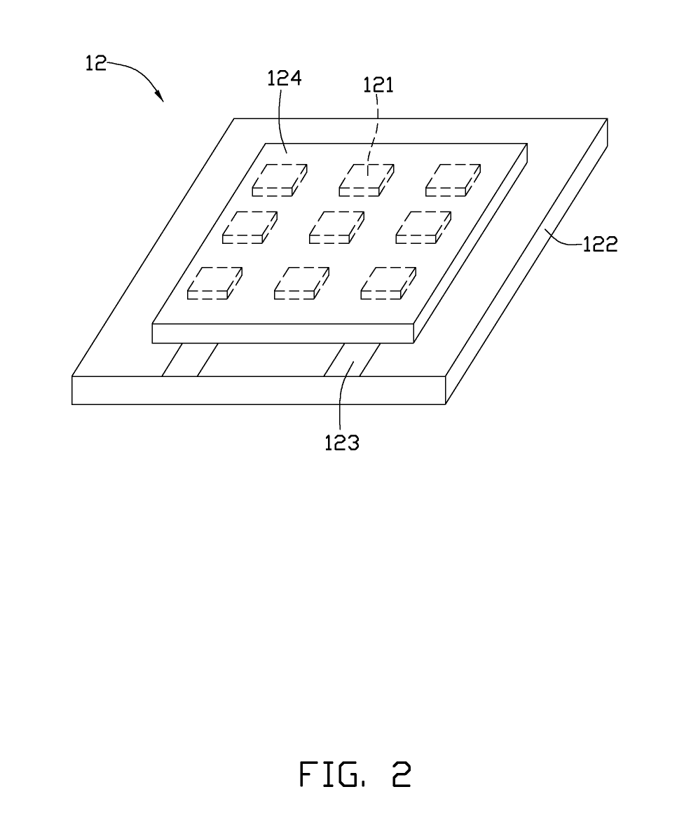

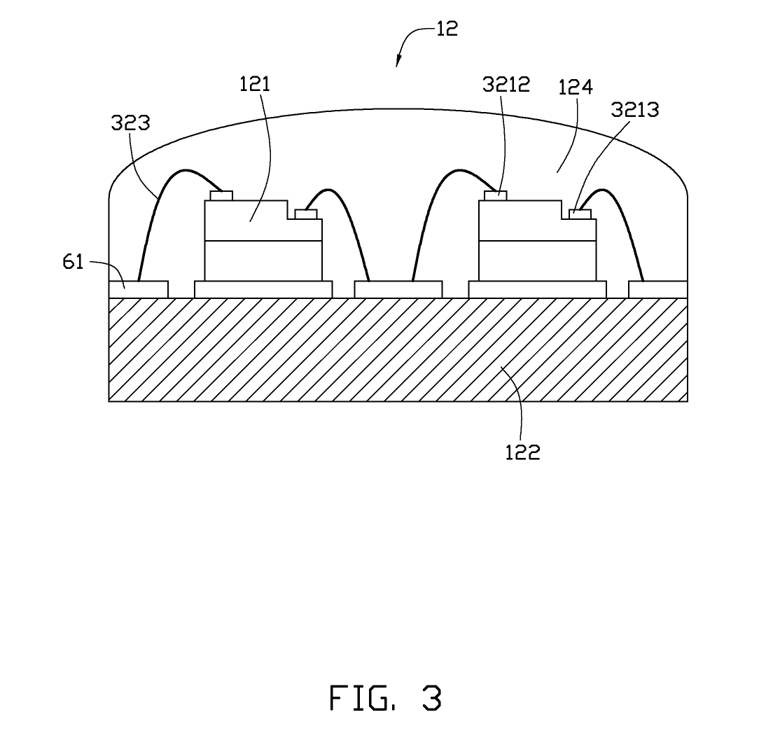

Referring to FIGS. 2 and 3, the LED module 12 includes a base 122, a plurality of chips 121 mounted on the base 122 and a package layer 124 formed on the base 122 and encapsulating the chips 121 therein.

Each chip 121 is made of phosphide such as AlₓInyGa_{(1-x-y)}P (0≦x≦1, 0≦y≦1, x+y≦1), arsenide such as AlInGaAs, oxide such as ZnO, nitride such as GaN, or a mixture thereof. The material of the chip 121 can emit light with wavelength varied between yellow light to red light. Preferably, the material of the chip 121 is a nitride compound (InₓAl_{y}Ga_{(1-x-y)}N, 0≦x≦1, 0≦y≦1, x+y≦1). The number of the chips 121 is nine in this embodiment. The chips 121 are spaced from each other and arranged in three parallel rows. The chips 121 of each row are electrically connected in series. The chips 121 of adjacent rows are electrically connected in parallel.

The base 122 includes a patterned metal layer 61 formed on a top surface thereof. The chips 121 are formed on the patterned metal layer 61 and electrically connected to the patterned metal layer 61 via wire bonding, in which two gold wires 323 are respectively soldered to connect terminals 3212, 3213 of the chip 121 and the patterned metal layer 61. Two spaced electrodes 123 are formed on the top surface of the base 122 to electrically connect a power source (not shown) and the chips 121 whereby power source can be supplied to the chips 121. The base 122 is electrically insulated from the chips 121 and absorbs heat generated by the chips 121.

The base 122 is an intrinsic semiconductor or a pure semiconductor. A carrier concentration of the base 122 is not larger than 5×10⁶ cm⁻³. Preferably, the carrier concentration of the base 122 is not larger than 2×10⁶ cm⁻³. The base 122 is made of spinelle, SiC, Si, ZnO, GaN, GaAs, GaP, AlN, or a mixture thereof. In other embodiment, the base 122 may be a diamond. The chips 121 are mounted on the base 122 by Ag gluing or eutectic bonding.

The packaging layer 124 is made of transparent, electrically insulating materials, such as silicone, epoxy, quartz, or glass. The packaging layer 124 encapsulates the LED chips 121 therein. The electrodes 123 exposes outwards from the packaging layer 124.

Referring to FIG. 1 again, the main body 11 is ceramic and made of Si₃N₄, SiC, ZrO₂, B₄C, TiB₄, AlₓO_{y}, AlN, BeO, Sialon or a mixture thereof. The main body 11 is a hollow frustum and an outer diameter thereof decreases from top to bottom. An inner diameter of the main body 11 also decreases from top to bottom. A supporting plate 113 is formed in the main body 11 adjacent to a top end thereof and divides an interior of the main body 11 into a first receiving chamber 111 and a second receiving chamber 112. The first receiving chamber 111 is over the second receiving chamber 112. Two through holes 114 are defined in the supporting plate 113 and intercommunicate the first and second receiving chambers 111, 112.

The LED module 12 is received in the first receiving chamber 111 and mounted on a central portion of a top surface of the supporting plate 113. The power module 15 is a cylinder and received in the second receiving chamber 112. The power module 15 electrically connects the electrodes 123 of the LED module 12 through wires (not shown) extending through the through holes 114. The power module 15 includes an AC-AC transformer, an AC-DC Converter, a DC-DC transformer, and a high power drive integrate circuit. The power module 15 transforms the alternating current to the directing current.

The connecting member 14 is a standard socket and mounted on a bottom end of the main body 11. The connecting member 14 seals the second receiving chamber 112 at the bottom end of the main body 11. The connecting member 14 electrically connects a power source (not shown) to drive the LED module 12 via the power module 15.

The cover 13 is transparent and has a hollow bowl-shaped configuration. The cover 13 is mounted on a top end of the main body 11 and seals the first receiving chamber 111 at the top end of the main body 11.

In this embodiment, the main body 11 of the LED lamp 10 is ceramic, the weight of LED lamp 10 is lighter than the conventional LED illumination device, thus the LED lamp 10 is easy to be disassembled or repaired. In addition, the ceramic is not easy to be corroded or expanded, therefore the LED lamp 10 has stable and reliable performance. Furthermore, the main body 11 of the ceramic is safe for users because of its electrical insulation.

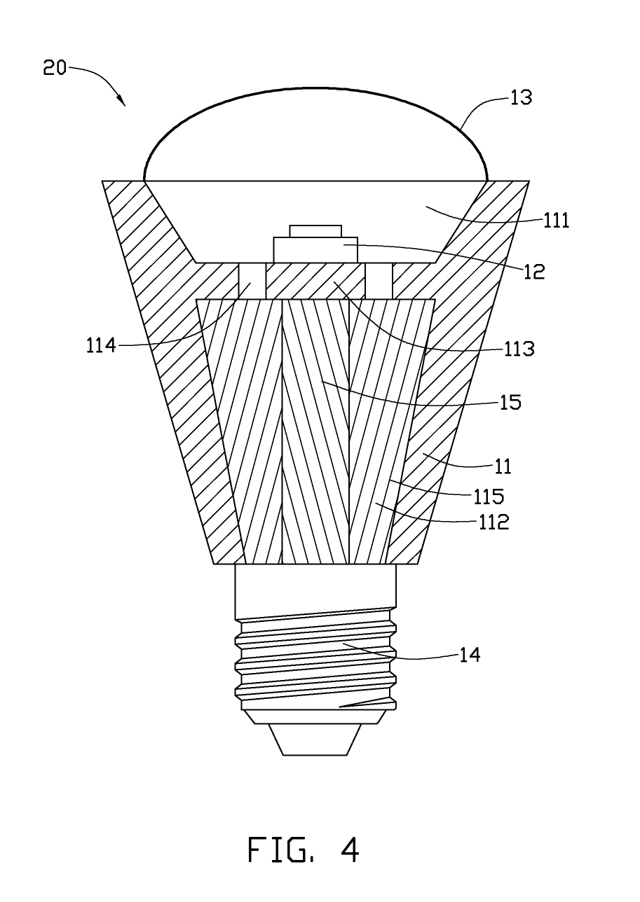

Referring to FIG. 4, an LED lamp 20 of a second embodiment is shown. The LED lamp 20 is similar to the LED lamp 10 of the first embodiment except that a heat conductive material 115 is filled in the second receiving chamber 112. The heat conductive material 115 is an electrically insulating material.

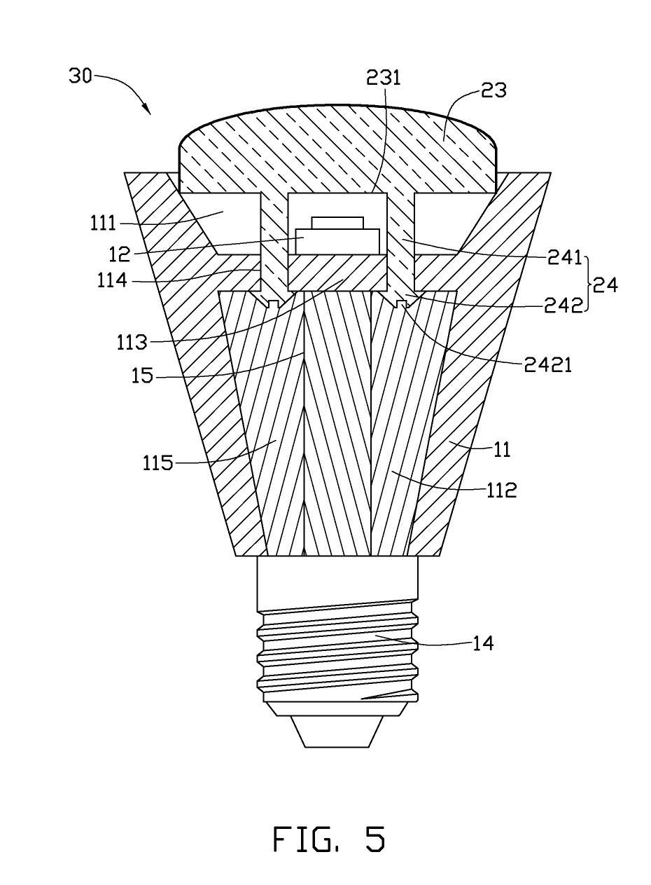

Referring to FIG. 5, an LED lamp 30 of a third embodiment is shown. The LED lamp 30 is similar to the LED lamp 20 of the second embodiment except the configuration of the cover 23. The cover 23 includes a solid covering portion 231 and two clips 24. The covering portion 231 is bowl-shaped and includes a plane bottom surface and a convex top surface opposite to the bottom surface. A bottom end of the covering portion 231 is received in the first receiving chamber 111 of the main body 11, and a periphery of the bottom end of the covering portion 231 abuts against an inner surface of the first receiving chamber 111.

The clips 24 extend from the bottom surface of the covering portion 231 and respectively align with the through holes 114 of the supporting plate 113 of the main body 11. Each clip 24 is elastic and includes a cylindrical connecting pole 241 extending from the covering portion 231 and a cone-shaped engaging portion 242 formed on a bottom end of the connecting pole 241. A diameter of the engaging portion 242 decreases from a top to bottom. A diameter of a top end of the engaging portion 242 is larger than that of the connecting pole 241 and the through hole 114. A diameter of the connecting pole 241 is equal to or slightly less than that of the through hole 114. The connecting poles 241 respectively extend through the through holes 114 and the engaging portions 242 extend into the heat conductive material 115 and elastically abut against and under the supporting plate 113. A central portion of a bottom end of the engaging portion 242 defines a recess 2421 therein to enhance an elastic deformation capability of the engaging portion 242.

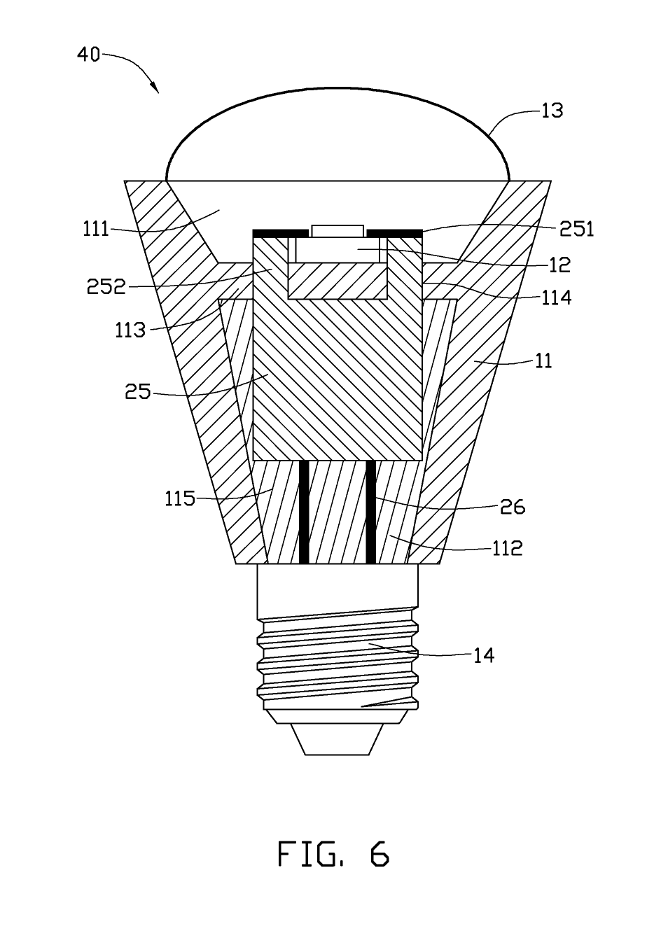

Referring to FIG. 6, an LED lamp 40 of a fourth embodiment is shown. The LED lamp 40 is similar to the LED lamp 20 of the second embodiment except the configuration of a power module 25 of the LED module 40. A bottom end of the power module 25 is spaced from the connecting member 14, and the heat conductive material 115 is filled therebetween to electrically insulate from the connecting member 14 and the power module 25. Wires 26 extend from the bottom end of the power module 25 and electrically connect the connecting member 14 and the power module 25. Two branches 252 are formed on a top end of the power module 25 and extend through the through holes 114 of the supporting plate 113. The branches 252 are located at lateral sides of the LED module 12 and spaced from the LED module 12. Two wires 251 are formed on top ends of the branches 252 and electrically connect the electrodes 123 of the LED module and the power module 25. In this state, the LED module 12 and the connecting member 14 are electrically connected by the power module 25.

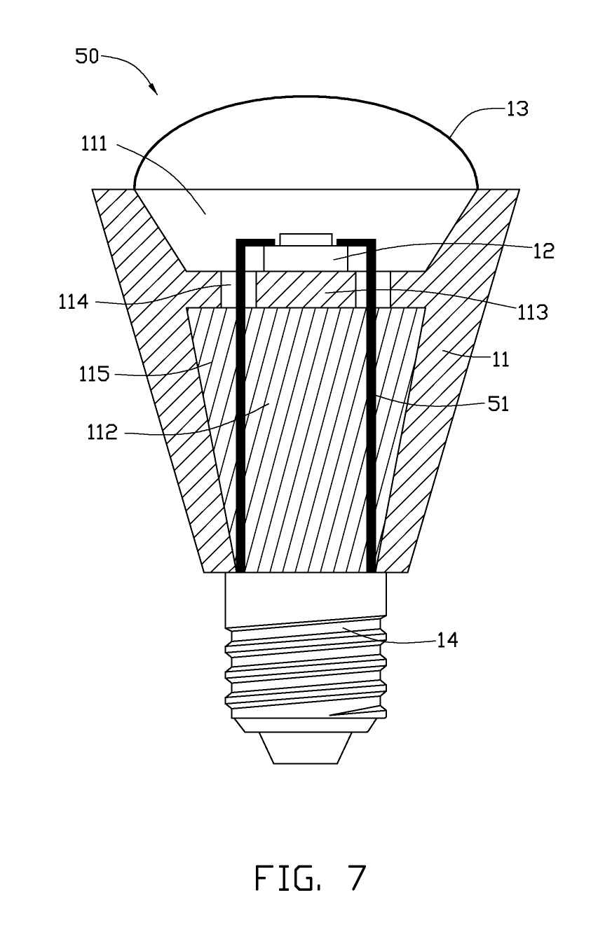

Referring to FIG. 7, an LED lamp 50 of a fifth embodiment is shown. Differently, power module is removed from the main body 11 of the LED lamp 50. The heat conductive material 115 is filled in the second receiving chamber 112. Two wires 51 electrically connect the electrodes 123 of the LED module 12 and the connecting member 14 directly, through the heat conductive material 115.

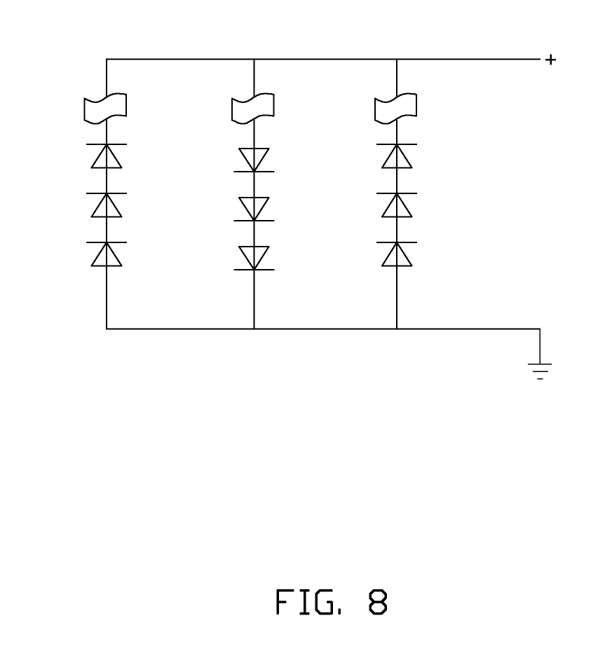

Referring to FIG. 8, the chips 121 of each row of the LED lamp 50 are connected in series. The chips 121 of adjacent rows are connected in parallel. In this state, the LED module 12 can electrically connect an alternating current source directly.

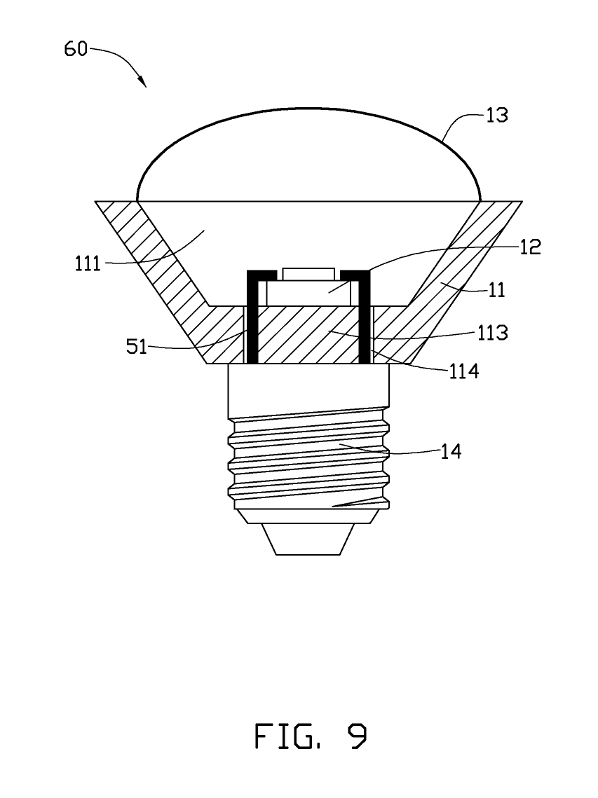

Referring to FIG. 9, an LED lamp 60 of a sixth embodiment is shown. The LED lamp 60 is similar to the LED lamp 50 of the fifth embodiment. The supporting plate 113 is directly formed on the bottom end of the main body 11 of LED lamp 60, whereby only the first receiving chamber 111 is defined in the main body 11 for receiving the LED module 12. The connecting member 14 is mounted on the bottom surface of the supporting plate 113.

It is to be understood, however, that even though numerous characteristics and advantages of the disclosure have been set forth in the foregoing description, together with details of the structure and function of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An LED (light emitting diode) lamp comprising:
a ceramic main body;
an LED module mounted in the main body;
a cover mounted on a top end of the main body and covering the LED module; and
a connecting member electrically connecting the LED module and mounted on a bottom end of the main body.

2. The LED lamp of claim 1, wherein the LED module comprises a base and a plurality of chips mounted on the base, and wherein two electrodes are formed on the base and electrically connect the connecting member and the LED module.

3. The LED lamp of claim 2, wherein a carrier concentration of the base is not larger than 5×10⁶ cm⁻³.

4. The LED lamp of claim 1, wherein the main body is hollow, the connecting member seals the bottom end of the main body, and the LED module and the connecting member are electrically connected by wires.

5. The LED lamp of claim 4, wherein a supporting plate with through holes defined therein is formed inside the main body, a first receiving chamber and a second receiving chamber are defined in the main body at opposite sides of the supporting plate, the LED module is received in the first receiving chamber and mounted on a top surface of the supporting plate, and the wires extend through the through holes to electrically connect the LED module and the connecting member.

6. The LED lamp of claim 5, wherein a heat conductive material is filled in the second receiving chamber.

7. The LED lamp of claim 5, wherein a power module is received in the second receiving chamber, and the power module electrically connects the LED module and the connecting member.

8. The LED lamp of claim 7, wherein a heat conductive material is filled in the second receiving chamber.

9. The LED lamp of claim 8, wherein a bottom end of the power module is spaced from the connecting member, wires extend from the bottom end of the power module and electrically connect the connecting member and the power module, branches are formed on a top end of the power module and extend through the through holes of the supporting plate and electrically connect the LED module.

10. The LED lamp of claim 8, wherein the cover comprises a solid covering portion received in the first receiving chamber and two elastic clips extending from the covering portion, the clips extending through the through holes and into the heat conductive material.

11. The LED lamp of claim 10, wherein the covering portion is bowl-shaped and has a plane bottom surface and a convex top surface opposite to the bottom surface, a bottom end of the covering portion is received in the first receiving chamber and a periphery of the bottom end of the covering portion abut against an inner surface of the first receiving chamber, and the top surface of the covering portion is located at an outside of the main body.

12. The LED lamp of claim 11, wherein the clips comprises a cylindrical connecting pole extending from the bottom surface of the covering portion and a cone-shaped engaging portion formed on a bottom end of the connecting pole, the connecting pole extends through a corresponding through hole of the supporting plate, and the engaging portion abuts against the supporting plate.

13. The LED lamp of claim 12, wherein a diameter of the engaging portion decreases from a top to a bottom thereof, and a diameter of a top end of the engaging portion is larger than that of the connecting pole and the corresponding through hole.

14. The LED lamp of claim 12, wherein a central portion of a bottom end of the engaging portion defines a recess therein.

15. The LED lamp of claim 4, wherein the cover has a hollow bowl-shaped configuration and seals the top end of the main body.

16. The LED lamp of claim 1, wherein the LED module comprises a patterned metal layer formed on the main body, and a plurality of chips formed on the patterned metal layer.

17. The LED lamp of claim 16, wherein each chip is electrically connected to the patterned metal layer through wire bonding, in which two gold wires are respectively soldered to connect terminals of the chip and the patterned metal layer.

18. The LED lamp of claim 1, wherein the main body is made of Si₃N₄, SiC, ZrO₂, B₄C, TiB₄, AlₓO_{y}, AlN, BeO, Sialon or a mixture thereof.

19. The LED lamp of claim 2, wherein the base is made of spinelle, SiC, Si, ZnO, GaN, GaAs, GaP, AlN, or a mixture thereof.

20. The LED lamp of claim 2, wherein each chip is made of phosphide, arsenide, oxide, nitride, or a mixture thereof.
